(19) United States
(12) Patent Application Publication
(10) Pub. No.: US 2007/0262175 A1
(43) Pub. Date: Nov. 15, 2007

(54) Joint in combination with a water source adevice and a cleaning head

(76) Inventor: Chen-Yueh Fan, Taipei (TW)

Correspondence Address: COOPER & DUNHAM, LLP, 1185 AVENUE OF THE AMERICAS, NEW YORK, NY, 10036, US

(21) Appl. No.: 11/430,306

(22) Filed: May 5, 2006

(51) Int. Cl. B05B 9/01

(52) U.S. Cl. 239/525; 239/310; 239/600

(57) ABSTRACT

A joint for combination with a water source device and a cleaning head includes a hollow body and a switch device. The body has an inlet adapted to connect to the water source device, an outlet in communication with the inlet and adapted to connect to a cleaning head and a chamber defined inside the body for receiving therein a cleaning agent and to selectively communicate with the outlet via a drainage hole defined in a side wall of the chamber. A switch device is pivotally mounted on a side of the body to control communication between an interior of the chamber and the outlet such that after the interior of the chamber communicates with the outlet of the body, the cleaning agent in the chamber is able to flow out of the body from the outlet simultaneously with clean water from the water source device.

### BACKGROUND OF THE INVENTION

1. Field of the Invention

The present invention relates to a joint, and more particularly to a joint adapted to be connected to a water source device and a cleaning head to selectively provide clean water and cleaning liquid simultaneously.

2. Description of the Prior Art

A bucket of water mixed with a kind of cleaning agent, a sponge and a water hose are necessary items if a person is trying to wash the windows. That is, the house owner needs to prepare a lot of “tools” so that the window-wash task can go smooth. However, preparing so many different items for such a simple task, considering the time and efforts trying to locate each of the items and putting them together, is annoying and too time-consuming. Similar examples can also be found inside the house. Imaging a lot of dishes and cups are in the kitchen sink and there is no help around, what can a housekeeper do? The housekeeper may choose using a sponge containing therein cleaning agent which is originally stored in a bottle and then poured onto the sponge to first clean the dishes and the cups. Thereafter, the housekeeper uses clean water from the faucet to wash off the cleaning agent. In other words, to clean whatever the objects are in the kitchen sink, the person has no option but to follow the above cleaning process step-by-step. In general, the cleaning process altogether takes too much time and effort to finish it.

To overcome the above shortcomings and to reduce the time and effort involved in the cleaning process, the present invention tends to provide an improved joint in combination with a water source device and a cleaning head to mitigate the aforementioned problems.

### SUMMARY OF THE INVENTION

The primary objective of the present invention is to provide an improved joint having therein a compartment for receiving therein a cleaning agent and a switch device mounted on the joint so that the cleaning agent is controlled to flow out of the joint with the clean water from the water source.

Another objective of the switch device of the present invention includes a linking arm having a distal end extending into the chamber and a driving arm having a distal end securely connected to a proximal end of the linking arm and a proximal end extending out of the joint so that an operator is able to control movement of the linking arm to select whether the cleaning agent in the chamber is going to flow out of the joint with the clean water.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the joint of the present invention;

FIG. 2 is a perspective view of the body of the joint of the present invention;

FIG. 3 is a perspective view showing that the present invention is connected to a water source on one side and a cleaning head on the other side of the body;

FIG. 4 is a partially schematic cross sectional view showing the inner structure of the body of the joint of the present invention;

FIG. 5 is a perspective view showing that the joint is connected to a series of cleaning heads; and

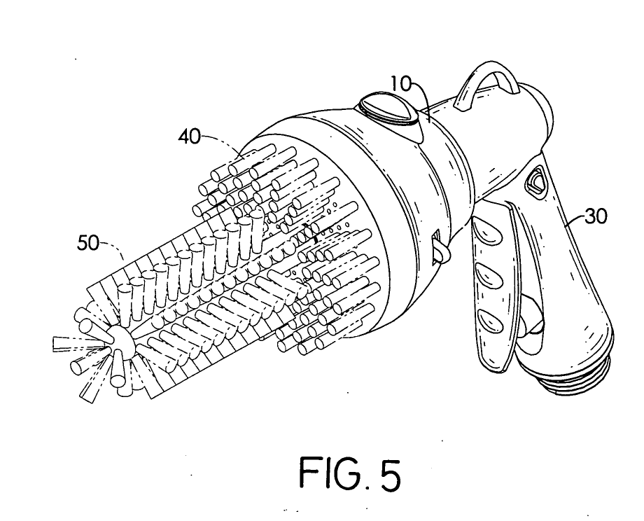

FIGS. 6 and 7 are schematic side plan views showing the movement of the switch device results in the effect that the cleaning agent received in the chamber is selectively flowing out of the chamber with the clean water from the water source.

### DETAILED DESCRIPTION OF THE PREFERRED EMBODIMENT

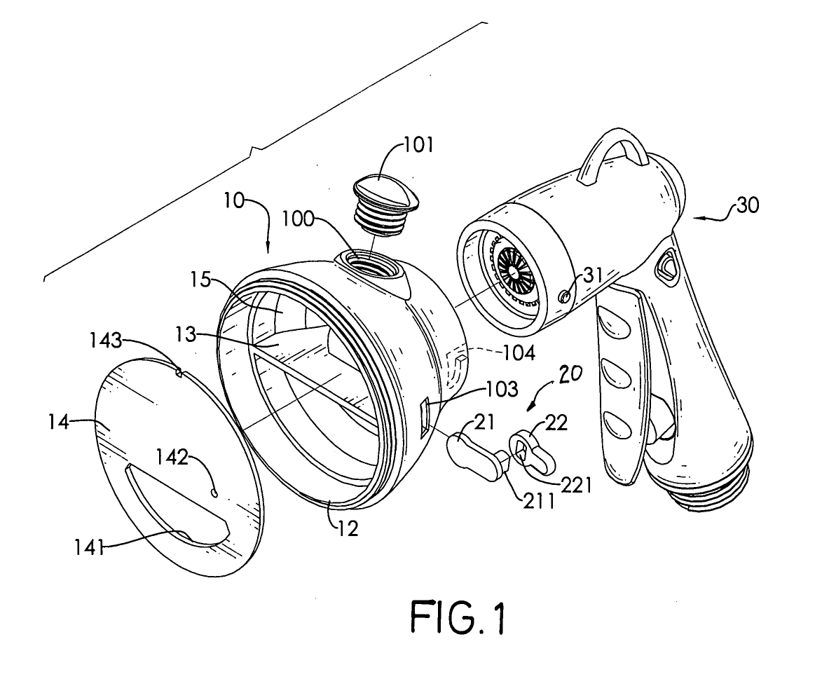

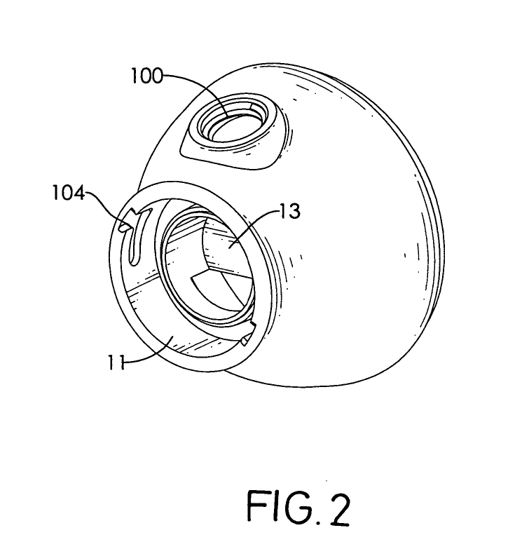

With reference to FIGS. 1 and 2, it is noted that the joint in accordance with the present invention includes a hollow and conical body (10) with an inlet (11) defied in one end of the body (10) and an outlet (12) defined in the other end of the body (10) to communicate with the inlet (11), a substantially L shaped first baffle (13) including a vertical half extending from an inner top face of the body (10) and a horizontal half extending horizontally from a free end of the vertical half to securely engage with opposite inner sides of the body (10) and a second baffle (14) formed inside the body (10) to substantially close the outlet (12) and orthogonally connected to a free side of the horizontal half of the first baffle (13), which defines a chamber (15) inside the body (10). It is noted that the body (10) also includes a feeding hole (100) defined through a periphery thereof to communicate with the chamber (15), a plug (101) threadingly extending into the feeding hole (100) to block the feeding hole (100), a pivot hole (103) defined in a side thereof to communicate with an interior of the body (10) and a pair of L-shaped combining recesses (104) respectively formed on two opposite inner sides defining the inlet (11). The second baffle (14) includes an opening (141) defined to communicate with both the inlet (11) and the outlet (12) such that even after the second baffle (14) is formed inside the body (10) to close the outlet (12), the inlet (11) can still communicate with the outlet (12) via the opening (141). A drainage hole (142) is defined through the second baffle (14) to communicate the outlet (12) with an interior of the chamber (15) and a positioning recess (143) defined in a peripheral edge of the second baffle (14) to ensure that the mounting of the second baffle (14) inside the body (10) allows only the drainage hole (142) communicates with the outlet (12).

A switch device (20) is provided to the body (10) of the present invention and includes a linking arm (21) having a distal end extending into the chamber (15) from the pivot hole (103) and a driving arm (22) having a distal end securely connected to a proximal end of the linking arm (21) and a proximal end extending out of the body (10). Preferably, the linking arm (21) has an extension (211) formed on a side of the proximal end of the linking arm (21) and the driving arm (22) has a connection hole (221) defined in the distal end of he driving arm (22) to correspond to and receive therein the extension (211) of the linking arm (21). It is further noted that the connection hole (221) and the extension (211) are so configured that after the extension (211) is extended into the connection hole (221), there is no relative movement between the driving arm (22) and the linking arm (21).

A water source device (30) is provided to the joint of the present invention and includes a pair of bosses (31) respectively formed on two outer sides of the water source device (30) to correspond to the L-shaped combining recesses (104) of the body (10). Therefore, it is easy to combine the body (10) and the water source device (30) if the bosses (31) are received in the corresponding combining recesses (104) and the body (10) is rotated to secure the bosses (31) inside the combining recesses (104).

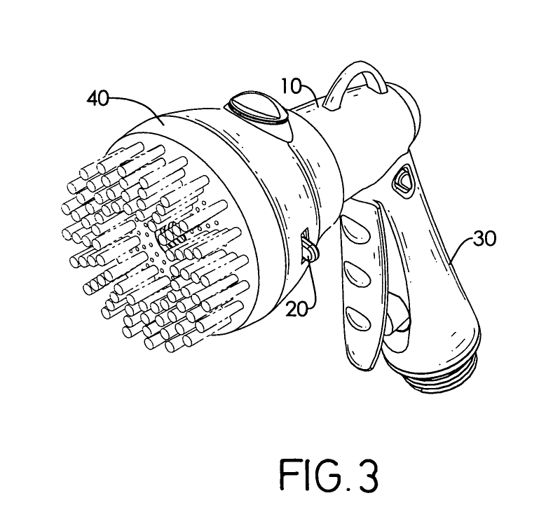

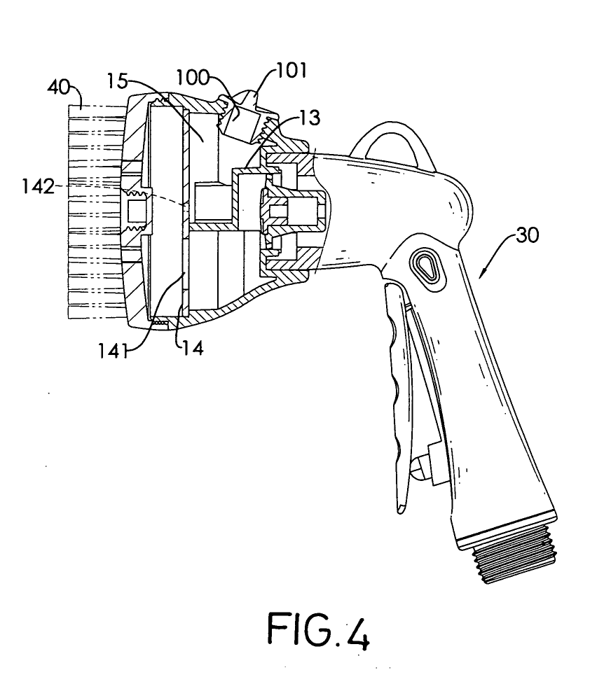

With reference to FIGS. 3 and 4, it is noted that a cleaning head (40) is able to be threadingly connected to the body (10) of the joint of the present invention. The cleaning head (40) has multiple holes defined therein to communicate with the outlet (12) of the body (10) such that the water from the water source device (30) is able to flow out of the cleaning head (40) via the holes. Furthermore, a second clean head (50) is able to be threadingly connected to the cleaning head (40) to increase the application areas of the combination thereof.

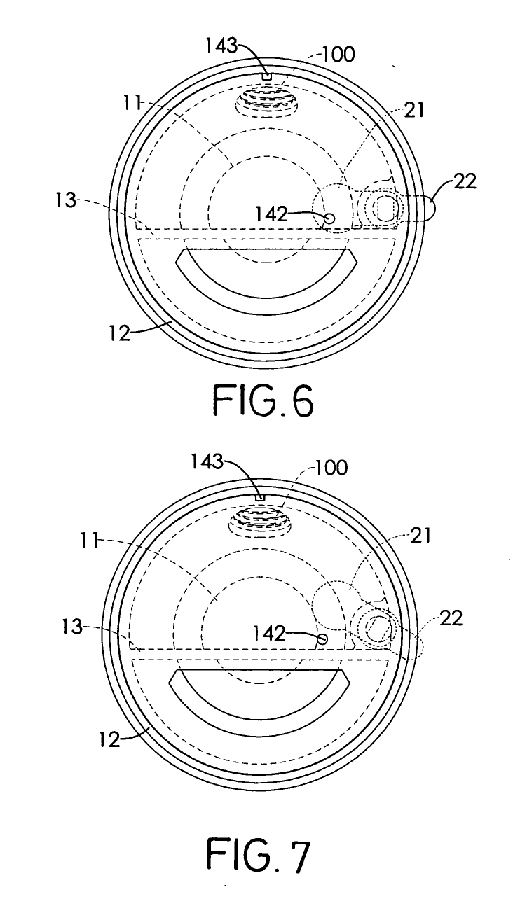

With reference to FIGS. 6, 7 and still using FIGS. 1 and 2 for reference, it is noted that after the joint of the present invention is assembled, the distal end of the linking arm (21) blocks the drainage hole (142). However, if the driving arm (22) is moved to drive the linking arm (21) to move accordingly, the outlet (12) communicates with the interior of the chamber (15). Therefore, if the plug (101) is removed and the linking arm (21) is pivoted by the driving arm (22) to block the communication between the interior of the chamber (15) and the outlet (12), the operator is able to fill the chamber (15) with a cleaning agent from the feeding hole (100). Then the plug (101) is again threadingly extend into the feeding hole (100) to prevent any leakage of the cleaning agent. Thereafter, the operator is able to use only clean water from the water source device (30) to proceed with any kind of cleaning tasks. However, the operator may also pivot the driving arm (22) to move the linking arm (21) so as to resume the communication between the interior of the chamber (15) and the outlet (12) such that when the clean water is flowing out of the body (10) from the outlet (12), a quasi-vacuum is generated, which allows the cleaning agent received inside the chamber (15) to flow simultaneously with the clean water. The cleaning agent mixed with the clean water facilitates the cleaning tasks dramatically in that the operator needs not prepare different tools to proceed the cleaning task. The operator only needs the joint to combine the water source device (30) with the cleaning head (30) and the cleaning task is readily finished.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A joint for combination with a water source device and a cleaning head, the joint comprising:
a hollow body having an inlet adapted to connect to the water source device, an outlet in communication with the inlet and adapted to connect to a cleaning head and a chamber defined inside the body for receiving therein a cleaning agent and to selectively communicate with the outlet via a drainage hole defined in a side wall of the chamber; and
a switch device pivotally mounted on a side of the body to control communication between an interior of the chamber and the outlet such that after the interior of the chamber communicates with the outlet of the body, the cleaning agent in the chamber is able to flow out of the body from the outlet simultaneously with clean water from the water source device.

2. The joint as claimed in claim 1, wherein the body further has an L-shaped first baffle formed on an interior of the body and a second baffle orthogonally connected to a free side of the first baffle to define therebetween the chamber and the drainage hole is defined in a side of the second baffle.

3. The joint as claimed in claim 1, wherein a feeding hole is defined in a side of the body to communicate with the interior of the chamber and a plug is removably mounted in the feeding hole such that the cleaning agent is able to be fed in the chamber when the plug is removed and leakage of the cleaning agent is prevented when the plug is securely received in the feeding hole.

4. The joint as claimed in claim 1, wherein the switch device is composed of a linking arm having a distal end extending into the chamber and a driving arm connected to a proximal end of the linking arm at a distal end thereof and a proximal end thereof extending out of the body so that movement of the driving arm is able to drive the linking arm to move and the distal end of the linking arm is able to selectively block the drainage hole to prevent the cleaning agent from flowing out of the chamber.

5. The joint as claimed in claim 2, wherein the switch device is composed of a linking arm having a distal end extending into the chamber and a driving arm connected to a proximal end of the linking arm at a distal end thereof and a proximal end thereof extending out of the body so that movement of the driving arm is able to drive the linking arm to move and the distal end of the linking arm is able to selectively block the drainage hole to prevent the cleaning agent from flowing out of the chamber.

6. The joint as claimed in claim 3, wherein the switch device is composed of a linking arm having a distal end extending into the chamber and a driving arm connected to a proximal end of the linking arm at a distal end thereof and a proximal end thereof extending out of the body so that movement of the driving arm is able to drive the linking arm to move and the distal end of the linking arm is able to selectively block the drainage hole to prevent the cleaning agent from flowing out of the chamber.

7. The joint as claimed in claim 6, wherein the body further has a pair of L-shaped combining recesses respectively and oppositely defined in an inner side defining the inlet so that the body is able to connect to the water source device readily with bosses respectively formed on two opposite sides of the water source device being received in the L-shaped combining recesses.
